(19) United States
(12) Patent Application Publication
(10) Pub. No.: US 2008/0184614 A1
(43) Pub. Date: Aug. 7, 2008

(54) APPARATUS AND SYSTEMS FOR USING SEMIOCHEMICAL COMPOSITIONS FOR INSECT PEST CONTROL

(76) Inventors: Bradley HIGBEE, Bakersfield, CA (US); Kristin KETNER, Bend, OR (US); Tom LARSEN, Bend, OR (US)

Correspondence Address: DALINA LAW GROUP, P.C., 7910 IVANHOE AVE. #325, LA JOLLA, CA, 92037, US

(21) Appl. No.: 11/866,356

(22) Filed: Oct. 2, 2007

Related U.S. Application Data
(60) Provisional application No. 60/827,878, filed on Oct. 2, 2006.

(51) Int. Cl. A01M 13/00

(52) U.S. Cl. 43/132.1

(57) ABSTRACT

An apparatus and system for using semiochemical compositions to control insect pests including the navel orangeworm. Includes a source of at least one semiochemical composition contained within a housing and a dispenser to initiate the controlled release of the composition over an area of treatment in response to one or more control signals. Compound release is achieved by adjusting start times and stop times, at intervals that coincide with periods of high activity for an insect pest or in response to trap capture data for the insect pest. A transmitter may be included report operation and status for monitoring purposes. Optional receiver allows for remote control. Release of the composition may also depend on signals from a light sensor, temperature sensor or other environmental factors such as wind, humidity and rain. May use more than one semiochemical composition to address different insect pests.

This application claims benefit of U.S. Provisional Patent Application Ser. No. 60/827,878 filed Oct. 2, 2006, which is hereby incorporated herein by reference.

### BACKGROUND OF THE INVENTION

1. Field of the Invention

One or more embodiments of the invention relate generally to apparatus and systems for using semiochemical compositions to reduce insect pest populations, such as the navel orangeworm, by, for example, causing mating disruption among members of the population.

2. Description of the Related Art

Insect pests such as the navel orangeworms, Amyelois transitella, are pests of tree nut crops such as almonds, pistachios, walnuts, and figs. Allowing such pests to breed unfettered results in a significant reduction in crop output and reduces profitability for the grower. Current recommendations for management of insect pests focus primarily on cultural practices and, if populations still threaten economic loss, on undesirable application of potentially toxic chemical insecticides as soon as the crop is susceptible and ovipositing females are present. Navel orangeworm larvae attack most soft-shell cultivars, or nuts with poor seal, feeding inside the nuts on the kernels. Navel orangeworm larvae cannot enter sound nuts before hullsplit so damage occurs after hullsplit and before harvest. Thirty percent damage is not uncommon in late harvested orchards and hence the economic consequences of such a reduction are often significant. Existing solutions for handling the navel orangeworm and other pest populations are expensive due to inefficiencies in handling the compositions used to control the insect population and the fact the compositions are quite expensive.

Hence, because of these and other limitations and problems with conventional treatment solutions, there is a need for more efficient and cost-effective apparatus and systems that can control a targeted pest population and that can be programmed to adapt and adjust to changing pest populations.

### BRIEF SUMMARY OF THE INVENTION

One or more embodiments of the invention relate generally to apparatus and systems for using semiochemical compositions, for example, that cause mating disruption among insect pests such as but not limited to the navel orangeworms, peach twig borers, oriental fruit moths, tomato pinworms, fall armyworms, omnivorous leaf rollers, vine mealybugs, aphids, mountain pine beetle, apple maggot, and the like. Semiochemical compositions include, but are not limited to, allelochemicals, pheromones, kairomones, or any combination thereof. Within allelochemicals pheromones and kairomones, as such semiochemicals may be referred as arrestants, attractants, repellents, deterrents, stimulants or other descriptive terms. These terms can indicate what behavior is involved in the response such as a feeding stimulant or flight arrestant or what basis of the interaction mediated, such as alarm, aggregation or sex pheromone.

In one embodiment the invention is an apparatus that causes mating disruption among insect pests that includes a movable housing or device that can be strategically placed within an area needing treatment. The apparatus includes a source of at least one semiochemical composition contained within the housing and a dispenser that is adapted to initiate the controlled release of the composition over an area of treatment in response to one or more control signals. The apparatus may be self-powered by batteries or may have some other external power source such as solar power.

In one embodiment, the semiochemical composition includes (Z,Z)-11, 13-hexadecadienal, and at least one of the following (Z,Z,Z,Z,Z)-3, 6, 9, 12, 15-tricosapentaene, (Z,Z,Z,Z,Z)-3, 6, 9, 12, 15-pentacosapentaene, (Z,Z)-11, 13-hexadecadien-1-ol. In one or more embodiments, several of the apparatus are spaced throughout an area of treatment (e.g., a field or orchard), such as in a grid pattern, checkerboard pattern or around the perimeter of the treatment area to provide for effective coverage. The apparatus may also be used in an enclosed environment such as in a residence (e.g., houseflies and mosquitoes), commercial or public facility (e.g., warehouse, food processing plants, feed stores or any facility where insect pest might be problematic). In one embodiment, the invention includes the use of a microprocessor to control the operation of the device and the release of the semiochemical composition.

In an embodiment, the invention includes the use of control signals to control the start times and stop times for the release of the semiochemical composition and includes control signals to modify the start times and the stop times. In one embodiment, the invention includes the use of a transmitter which can transmit signals indicative of one or more operational parameters of the apparatus and can allow for the apparatus to be monitored. Two or more apparatus may use telemetry in a treatment area to monitor and coordinate a treatment program.

In one embodiment, the invention may be configured for a controlled release of the composition at intervals that coincide with periods of high activity for an insect pest. The invention may also be used in conjunction with data from insect traps. In this embodiment, the release of the composition may be in response to trap capture data for the insect pest or trap capture data that includes acoustic data reflective of the identification of the particular insect pest. It has been found that particular pests emit a unique acoustic signal based on the pest's wing motions which allows the pest to be identified by its acoustic signal.

In one embodiment, the invention may be configured with an acoustic device that emits a sound that adversely affects the behavior of an insect pest. Such sound can interfere with communication of insect pests to effect behavior, such as interfering acoustic signals involved in mate localization.

In one embodiment, the flow rate of the release of the composition is adjusted depending in the activity of the insect pest. For example, it is desirable to minimize the quantity of certain semiochemical loaded into the apparatus and distributed at the area of treatment to between a range of one to sixteen grams per acre per season. It is possible to control an insect population using other amounts, but when amounts exceed 16 grams the quantities used become cost prohibitive.

In one or more embodiments, the release of the composition is dependent on signals from a light sensor or a temperature sensor or other environmental factors such as sun, wind, humidity and rain (e.g., decomposition or dissipation of the composition). The use of one or more light sensors allows for the release of the composition to be adjusted, or turned off and on, based on the time of day or the season. For example, in one or more embodiments of the invention, the compositions are released at dusk and/or dawn. As the time of such release changes throughout the season the apparatus automatically adjust so as to perform the release at the appropriate time.

In one embodiment, the release of the composition is dependent on signal from a sensor that monitors atmospheric concentration of the composition. For example, the level of an atmospheric concentration of the composition may be dependent on environmental factors such as sun, wind, humidity and rain.

In one embodiment, the apparatus provides for controlled release of different semiochemical compositions in response to insect trap capture data reflective of particular insect pests.

Other objects, features and advantages of the present invention will become apparent to those skilled in the art from the figures and detailed description of the invention.

### DESCRIPTION OF THE FIGURES

Additional objects and features of the present invention will become more apparent and the invention itself will be best understood from the following Detailed Description when read with reference to the accompanying drawings.

FIG. 1 is a top view of one embodiment of the apparatus of the present invention.

FIG. 2 is an exploded view illustrating one embodiment of the apparatus of the present invention.

FIG. 3 is an exploded view illustrating an embodiment of the apparatus of the present invention.

FIG. 4 is a perspective view showing one embodiment of housing for the apparatus of the present invention.

FIG. 5 is a close-up top view of one embodiment of a spray nozzle for the apparatus of the present invention.

### DETAILED DESCRIPTION OF THE INVENTION

Apparatus and systems for use of semiochemical compositions for controlling insect pests are described herein. In the following description, for the purposes of explanation, numerous specific details are set forth to provide a thorough understanding of the invention. It will be apparent, however, to one skilled in the art that the present invention may be practiced without these specific details.

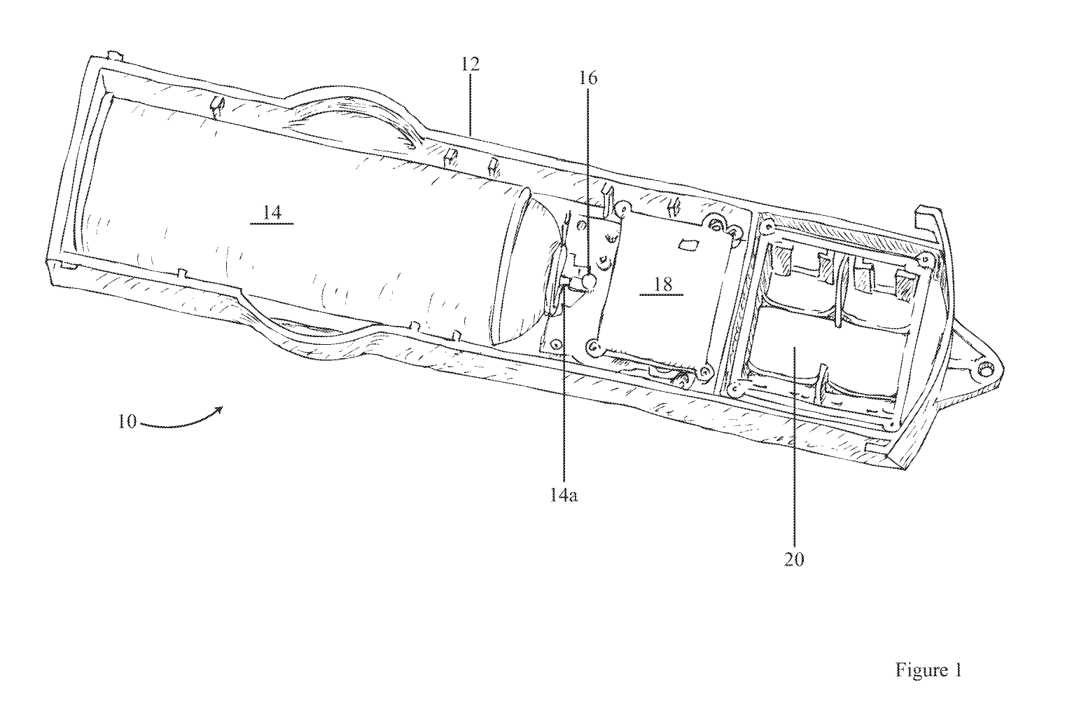

In one embodiment, the apparatus 10 includes a housing 12 that is of an elongated rectangular cross-section as shown in FIG. 1, although other shapes and configurations are within the scope of the invention. Within the housing 12 is the source 14 of the semiochemical composition which in one embodiment is a removable aerosol can as shown in FIG. 1 which can be arranged within the housing 12 as shown in FIG. 1. The invention includes the use of small canisters as the source 14 so that the invention can be used in an enclosed environment such as in a residence, or public facility and also may be placed in a tree in an orchard with multiple apparatus placed in the tree.

The invention includes the use of more than one semiochemical composition and includes the use of additional sources 14 within the housing 12. The spray tip 14a of the source 14 is shown in FIG. 1 attached to a dispenser 16, also known as a puffer and includes other devices including any type of microsprayer for example.

In one embodiment, the semiochemical composition for mating disruption is (Z,Z)-11, 13-hexadecadienal, and at least one of the following (Z,Z,Z,Z,Z)-3, 6, 9, 12, 15-tricosapentaene, (Z,Z,Z,Z,Z)-3, 6, 9, 12, 15-pentacosapentaene, (Z,Z)-11, 13-hexadecadien-1-ol but other compositions are within the scope of the invention. See Table 1 for non-limiting examples of semiochemical compositions that target particular insect pests. As used herein, the term “insect pest” refers to any insect that is disruptive or destructive to the growth and development of agricultural crops. In one embodiment of the invention, the insect pest is the navel orangeworm and other insect pests are within the scope of the invention.

TABLE 1
Insect Pheromones and Other Semiochemicals

| Common Name | | | | Approximate |
|---|---|---|---|---|
| (Acronym) | Semiochemical | | | Ratio |
| Peach Twig | E-5-decenyl | E-5-decenol | | 83:17 |
| Borer (PTB) | acetate | | | |
| Oriental Fruit | Z-8-dodecenyl | E-8-dodecenyl | E-8- | 90:6:4 |
| Moth (OFM) | acetate | acetate | dodecenol | |
| False Codling | E-8-dodecenyl | Z-8-dodecenyl | | 90:10 |
| Moth (FCM) | acetate | acetate | | |
| European Grape | Z-9-dodecenyl | | | 100 |
| Berry Moth (EA) | acetate | | | |
| Grapevine Moth | E,Z-7,9- | | | 100 |
| (LB) | dodecadienyl | | | |
| | acetate | | | |
| Codling Moth | E,E-8,10- | | | 100 |
| (CM) | dodecadienol | | | |
| Tomato Pinworm | E-4-tridecenyl | Z-4- | | 97:3 |
| (TPW) | acetate | tridecenyl | | |
| | | acetate | | |
| Fall Armyworm | Z-9- | Z-11- | Z-7- | 80:19.5:0.5 |
| (FAW) | tetradecenyl | hexadecenyl | dodecenyl | |
| | acetate | acetate | acetate | |
| Omnivorous | E-11- | Z-11- | | 80:20 |
| Leafroller | tetradecenyl | tetradecenyl | | |
| (OLR) | acetate | acetate | | |
| Oblique-banded | Z-11- | E-11- | | 98:2 |
| Leafroller (OBLR) | tetradecenyl | tetradecenyl | | |
| | acetate | acetate | | |
| Stored Product | Z,E-9,12- | | | 100 |
| Moth (SPM) | tetradecadienyl | | | |
| | acetate | | | |
| Raisin Moth | Z,E-9,12- | | | 100 |
| (RM) | tetradecadienyl | | | |
| | acetate | | | |
| Beet Armyworm | Z,E-9,12- | Z-11- | | 90:10 |
| (BAW) | tetradecadienyl | hexadecenyl | | |
| | acetate | acetate | | |
| Diamondback | Z-11- | Z-11- | | 50:50 |
| Moth (DBM) | hexadecenal | hexadecenyl | | |
| | | acetate | | |
| Artichoke Plume | Z-11- | | | 100 |
| Moth (APM) | hexadecenal | | | |
| Navel | Z,Z-11,13- | | | 100 |
| Orangeworm | hexadecadienal | | | |
| (NOW) | | | | |
| Pink Bollworm | Z,E-7,11- | Z,Z-7,11- | | 50:50 |
| (PBW) | hexadecadienyl | hexadecadienyl | | |
| | acetate | acetate | | |
| Western Poplar | E,Z-3,13- | Z,Z-3,13- | | 80:20 |
| Clearwing Moth | octadecadienol | octadecadienol | | |
| (WPCM) | | | | |
| Gypsy Moth | cis-7,8-epoxy-2- | | | 100 |
| (GM) | methyloctadecane | | | |
| | (disparlure) | | | |
| Vine Mealybug | lavandulyl | | | 100 |
| (VMB) | senecioate | | | |
| Aphid Alarm | E-β- | | | 100 |
| Pheromone | farnesene | | | |
| (AAP) | | | | |
| Mountain Pine | verbenone | | | 100 |
| Beetle (MPB) | | | | |
| Apple Maggot Fly | 1-octen-3-ol | 3-methyl-1- | | 50:50 |
| Repellent (AMR) | | butanol | | |
| Oriental Beetle | Z-7- | | | 100 |
| (OB) | tetradecen- | | | |
| | 2-one | | | |

FIG. 1 also shows the controls 18 placed adjacent to the source 14 and which control the release of the semiochemical composition from the source 14. Adjacent to the controls 18 is the battery compartment 20 which is shown empty in FIG. 1. In one embodiment, batteries are placed within the battery compartment 20 to provide a power source for the controls 18 and the operation of the dispenser 16.

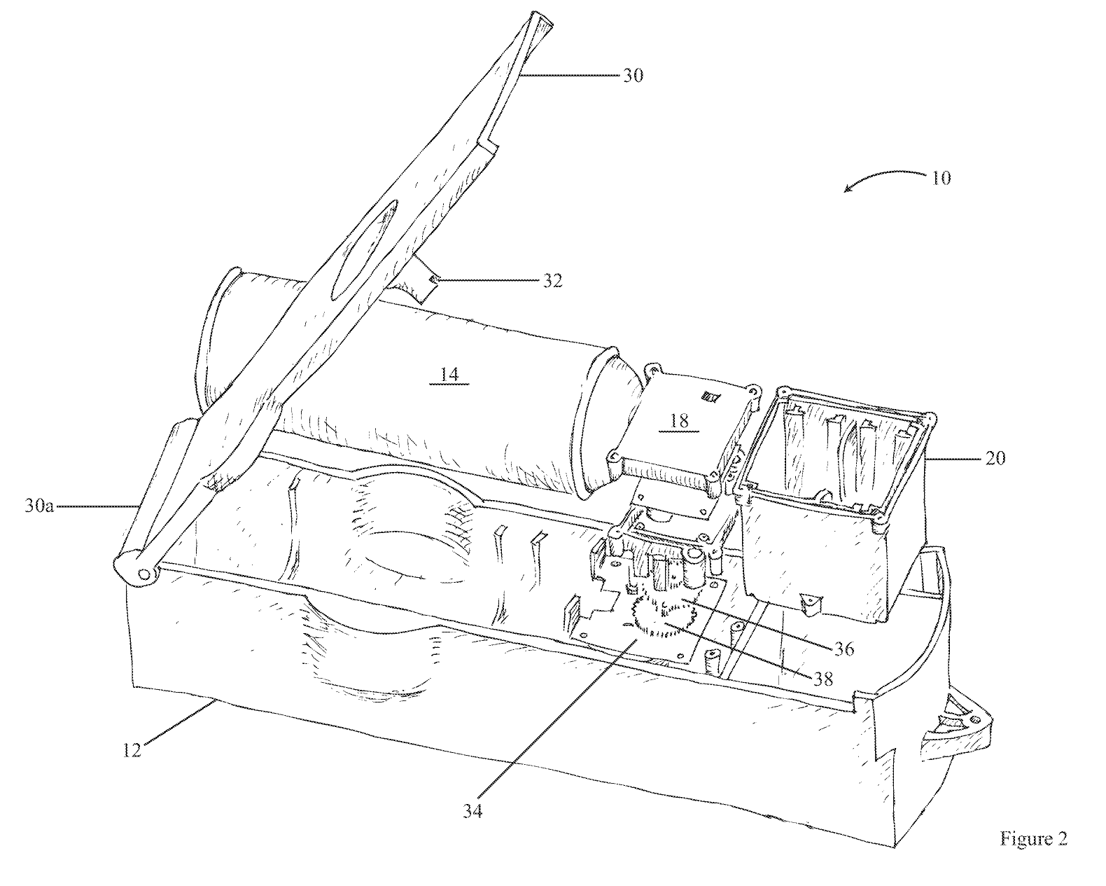

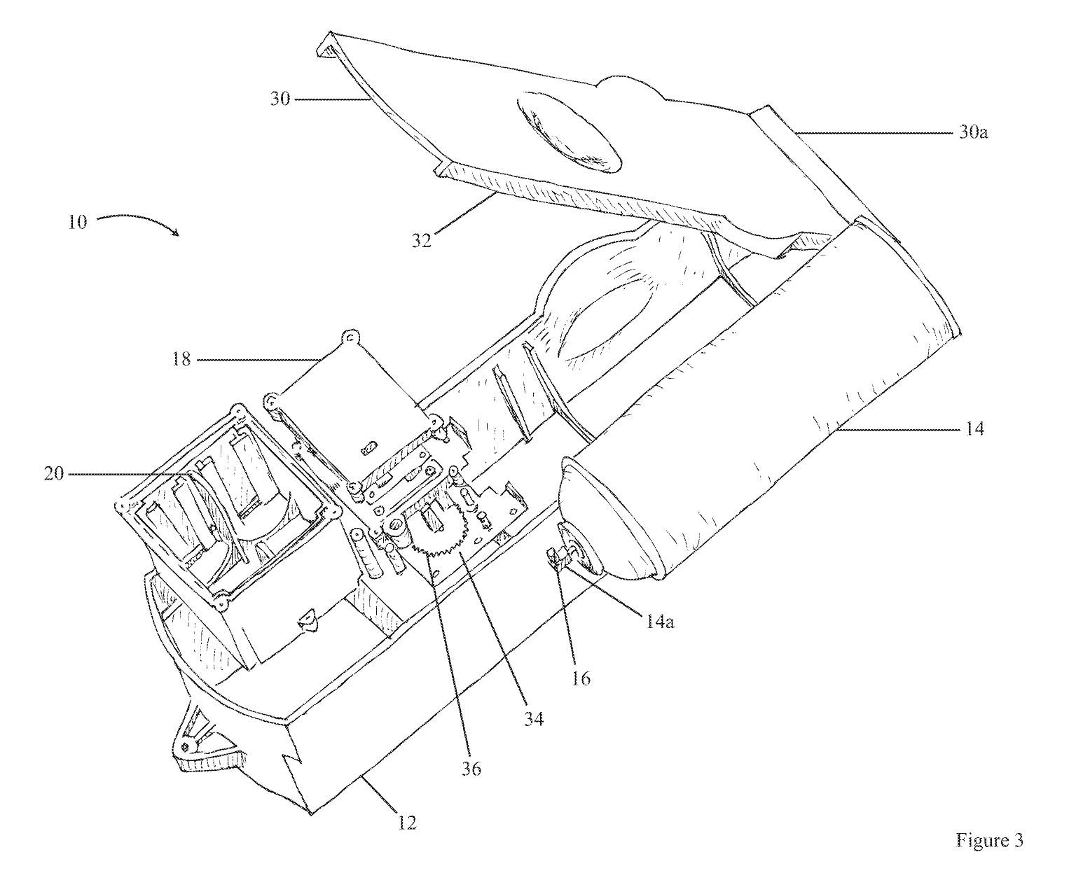

FIG. 2 illustrates an exploded view of one embodiment of the apparatus 10 of the invention. In this Figure, the cover 30 for the housing 12 is shown to fit over the housing 12 and may provide a barrier to wind or rain and also provide ultraviolet protection. The cover 30 may be removably connected to the housing 12 by a hinge 30a and other types of connections are within the scope of the invention. The cover 30 includes an opening 32 adapted to fit over the dispenser 16 when the cover 30 is closed so that the composition can be dispensed to the environment. The controls 18 include control board 34 which may include control wheels 36 and 38 which, in one embodiment, operate to control the dispenser 16 to release the composition at selected time intervals. FIG. 3 shows an exploded view of the apparatus 10 from the opposite side of the housing 12 to which the same description above applies.

In one operational embodiment of the invention, the composition is dispensed from the source 14 by triggering the dispenser 16 i.e., pushing on the dispenser 16, in response to rotation of the control wheels 36 and 38 which respond to control signals from the controls 18 in an operation.

In one embodiment, the controls 18 include a microprocessor that sends control signals to control the operation of the dispenser 16 and the invention includes any forms and types of computer control. For instance, in one or more embodiments of the invention, the apparatus 10 releases the composition at a start time and a stop time or the apparatus 10 can have multiple start and stop times. The release can be for a particular duration or for a particular amount of semiochemical composition. In still further embodiments, the start times and stop times are modified depending on the insect population or other factors. In an embodiment, the controlled release of the composition and other operating parameters of the apparatus 10 are programmed through use of software and coding into a computer control. Any method of operating dispenser 16 through a computer in configured to activate and deactivate dispenser via software associated with the computer in controls 18 is in keeping with the spirit of the invention.

In another embodiment, the release of the composition occurs upon a triggering event, including but not limited to, at times to coincide with periods of high activity for an insect pest, in response to trap capture data for an insect pest, or in response to specific insect trap capture data including acoustic data reflective of a particular insect pest. The invention includes the controlled release of different semiochemical compositions and in response to trap capture data reflective of particular insect pests or in response to control signals reflective of such trap capture data.

In one or more embodiments, the apparatus 10 includes a transmitter which can transmit signals indicative of one or more operational parameters of the apparatus 10. These operation parameters include, but are not limited to, start and stop times for the release of the composition, quantity of composition released or signals indicative of the quantity of composition remaining in the source 14 and operational power status, including battery status and battery failure and other such parameters for example. The signals sent by the transmitter can be used and analyzed by monitoring personnel, such as the property owner, to update or adjust the operation of the apparatus, to create a database, or if needed, to take out the empty aerosol source 14 and replace it with a new one.

In one or more embodiments of the invention, apparatus 10 includes a receiver configured to interface with controls 18 in order to “network” and remotely operate apparatus 10. Any type of wireless communication medium may be utilized in remotely communicating with apparatus 10. Any pattern of operation may be utilized including multiple simultaneous commands to multiple different apparatus to release composition, or any other geometric or time oriented pattern of operation of multiple devices.

In one embodiment, the invention includes use of one or more light sensors to provide signals indicative of light strength and duration. For example, the data provided by the light sensor can be used to adjust the release of the composition at intervals coinciding with reduced light exposure depending on whether it is dusk, dawn, high noon or nighttime. Releases of the composition can be seasonally adjusted based on the time of the year and shorter or longer daylight hours.

In one embodiment of the invention, the controlled release of the composition is dependent on the temperature including ambient temperature of the area of treatment. In one embodiment, the invention includes the use of one or more temperature gauges. In another embodiment, the release of the composition may be stopped in response to the temperature such as when the temperature drops below a threshold value which may be dependent on the particular insect pest.

In one embodiment, the release of the composition is dependent on one or more environmental factors and such factors include, but are not limited to, wind conditions, humidity conditions and rain conditions at the area of treatment and the invention includes the use of any appropriate wind and humidity sensors. The present invention includes the use of control signals for the controlled release of the composition in which the release is dependent on one or more environmental factors.

In one embodiment, the release of the composition is dependent on signal from a sensor that monitors atmospheric concentration of the composition. For example, the level of an atmospheric concentration of the composition may be dependent on environmental factors such as sun, wind, humidity and rain. Measurement of the atmospheric concentration of semiochemical composition is carried out by a semiochemical detector such as gas chromatography with electroantennographic detection (GC-EAD), electroantennogram (EAG), or any device with sensor capable of detecting semiochemical composition in the atmosphere. Electroantennogram refers to the output of a device incorporating electrodes that measure electrical activity across an antenna of insect pest of interest mounted in conductive medium (e.g., electrode gel). In this manner, the response of receptors on the antenna to stimuli (e.g., semiochemicals) including odors can be quantified.

The invention allows for the control and/or calibration of the release of the semiochemical composition in the field condition by using the measurement data for an atmospheric concentration of the composition in the vicinity of the apparatus. Semiochemical detector can be positioned, typically between the positions of two adjacent apparatus in a field, and operated to measure the atmospheric concentration. A pre-defined treatment program using atmospheric concentration measurement may coordinate the apparatus to release a desired amount or rate of semiochemical composition in the atmosphere.

Treatment program may act on the data measured by the semiochemical detector indicative of a threshold value to elicit a desired behavior (e.g. mating disruption) from insect pest which acts on the semiochemical composition released in the atmosphere, the signal is then sent (e.g., wired or via telemetry) to the apparatus to adjust and control the rate of release, the timing of release, the amount of release, the blend ratio of semiochemical compositions, the other factors affecting dispersion (e.g., pattern), or any combination thereof.

Alternatively, an air sample may be taken from the vicinity of the apparatus in the field condition and the atmospheric concentration measurement may be performed with the semiochemical detector in a laboratory (e.g., not in the field). As such, the results of the atmospheric measurement can be used to design a treatment program, of which the treatment program is then sent (e.g., wired or via telemetry) to the apparatus to control the operational parameters.

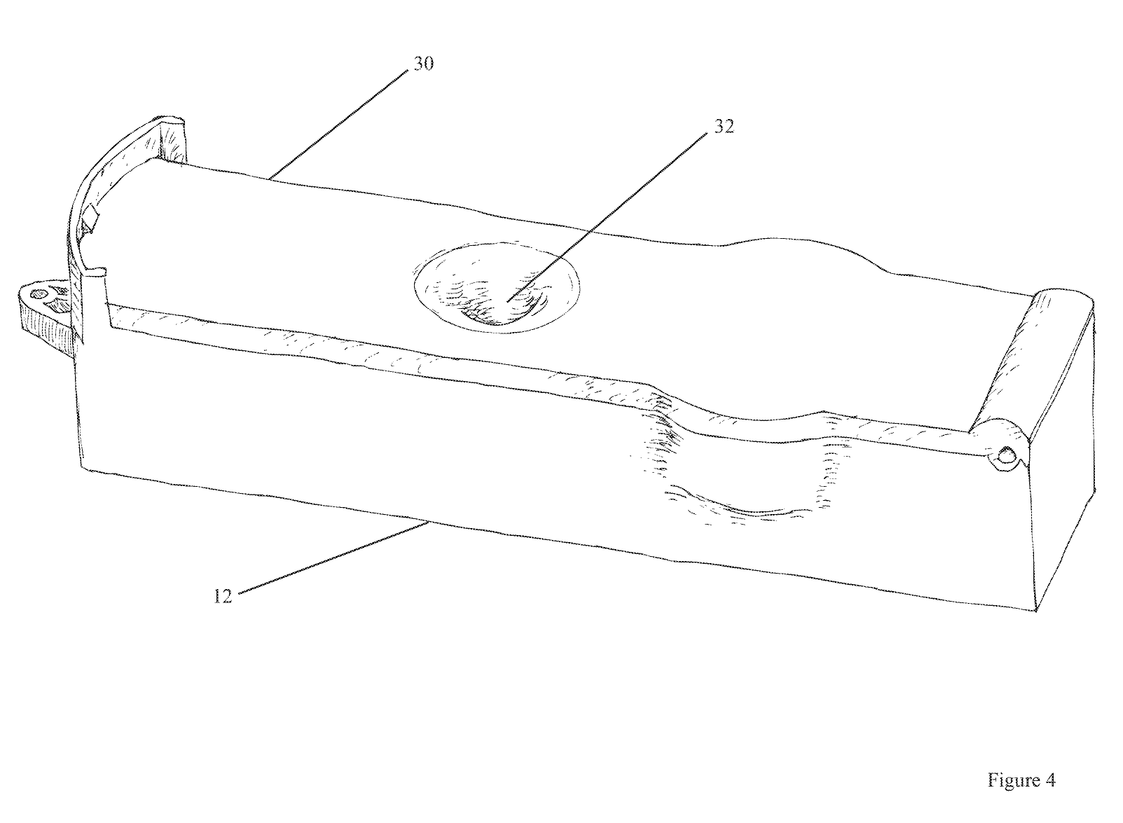

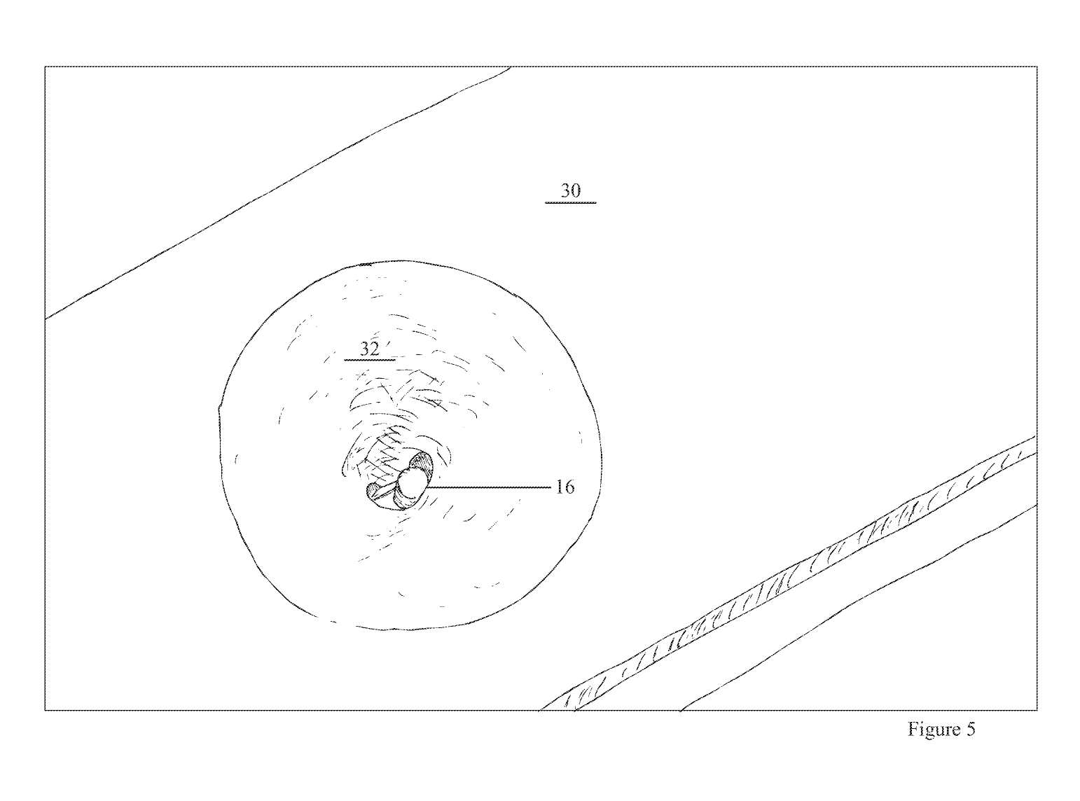

FIG. 4 shows the housing 12 with the cover 30 closed to provide an enclosure that can provide protection from wind, rain and minimizing exposure to light which has a degrading effect on the composition. FIG. 5 illustrates a close-up view of one embodiment of the dispenser 16 as it protrudes from the opening 32 in the cover 30.

From the foregoing, apparatus and systems for using a semiochemical composition for insect pests control have been disclosed. While the invention has been described with reference to specific embodiments and specific features, the description herein is illustrative of the invention and is not to be construed as limiting the invention to particular embodiments or combination of features. Numerous modifications and applications may occur to persons skilled in the art without departing from the true spirit and scope of the invention as described by the appended claims including the full breadth and scope of equivalents thereof.

What is claimed is:

1. An apparatus for controlling insect pests comprising:
a source of at least one semiochemical composition within a housing; and,
a dispenser in communication with said source and adapted to initiate controlled release of said composition over an area of treatment in response to one or more control signals.

2. The apparatus of claim 1 where said semiochemical composition comprises (Z,Z)-11,13-hexadecadienal, and at least one of the following (Z,Z,Z,Z,Z)-3,6,9,12,15-tricosapentaene, (Z,Z,Z,Z,Z)-3,6,9,12,15-pentacosapentaene, (Z,Z)-11,13-hexadecadien-1-ol.

3. The apparatus of claim 1 where said source comprises an aerosol can.

4. The apparatus of claim 1 where said control signals are from a microprocessor.

5. The apparatus of claim 1 where said control signals are adapted to control start times and stop times of said controlled release.

6. The apparatus of claim 5 where said start times or said stop times can be modified.

7. The apparatus of claim 1 where said housing comprises a transmitter.

8. The apparatus of claim 7 where said transmitter transmits signals indicative of one or more operational parameters of said apparatus.

9. The apparatus of claim 8 where said operational parameters include times for said controlled release, quantity of said synthetic hormone dispensed or power status.

10. The apparatus of claim 1 where said controlled release occurs at intervals that coincide with periods of high activity for said insect pest.

11. The apparatus of claim 1 where said controlled release is in response to trap capture data for said insect pest.

12. The apparatus of claim 11 where said trap capture data comprises acoustic data reflective of the identification of said insect pest.

13. The apparatus of claim 1 where said control signals are adapted to control the flow rate of said controlled release.

14. The apparatus of claim 1 where said controlled release occurs upon the occurrence of a triggering event.

15. The apparatus of claim 1 further comprising a light sensor for controlling the release of said composition.

16. The apparatus of claim 1 where said controlled release is temperature dependent.

17. The apparatus of claim 16 where said controlled release stops in response to data reflective of temperature of said area of treatment.

18. The apparatus of claim 1 where said controlled release is dependent on data reflective of wind conditions.

19. The apparatus of claim 1 where said controlled release is dependent on data reflective of rain conditions.

20. The apparatus of claim 1 where said apparatus provides controlled release of different semiochemical compositions in response to trap capture data reflective of insect pests.
